(19) United States
(12) Patent Application Publication
(10) Pub. No.: US 2012/0211230 A1
(43) Pub. Date: Aug. 23, 2012

(54) SUBSEA SEPARATION SYSTEMS

(76) Inventors: Karl Gregory Anderson, Missouri City, TX (US); Raul Jasso Garcia, SR., Houston, TX (US); Raghunath Gopal Menon, Katy, TX (US); Sandeep Patni, Houston, TX (US); Moye Wicks, III, Houston, TX (US); Patrick Gitau Mahinda, Pearland, TX (US); Rajneesh Varma, Houston, TX (US)

(21) Appl. No.: 13/503,869

(22) PCT Filed: Oct. 25, 2010
(86) PCT No.: PCT/US10/53911

§ 371 Date: Apr. 25, 2012

Related U.S. Application Data
(60) Provisional application No. 61/255,212, filed on Oct. 27, 2009.

(51) Int. Cl. E21B 43/36; B04C 5/04; B01D 17/00; B04C 5/00; B01D 17/038; B01D 19/00

(52) U.S. Cl. 166/335; 210/787; 210/747.1; 210/512.1; 95/261; 210/788; 210/170.01; 96/216

(57) ABSTRACT

A method for separating a multi-phase fluid, the fluid comprising a relatively high density component and a relatively low density component, the method comprising: introducing the fluid into a separation region; imparting a rotational movement into the multi-phase fluid; forming an outer annular region of rotating fluid within the separation region; and forming and maintaining a core of fluid in an inner region; wherein fluid entering the separation vessel is directed into the outer annular region; and the thickness of the outer annular region is such that the high density component is concentrated and substantially contained within this region, the low density component being concentrated in the rotating core.

### FIELD OF THE INVENTION

The present invention is directed to subsea separation systems.

### BACKGROUND OF THE INVENTION

U.S. Pat. No. 6,036,749 discloses a liquid/gas helical separator that operates on a combination of centrifugal and gravitational forces. The separator includes a primary separator formed basically by an expansion chamber, a secondary separator formed basically by a helix for directing the flow, a tertiary separator which consists of a reservoir or gravitational-separation tank and of a transition region between the primary and secondary separators, which consists of at least two variable-pitch helixes whose inclination varies from an angle of 90 DEG to the angle of inclination of the constant-pitch helix of the secondary separator with the function of providing a gentler flow of the liquid phase at the transition between the first two separators. U.S. Pat. No. 6,036,749 is herein incorporated by reference in its entirety.

U.S. Pat. No. 7,540,902 discloses a slug flow separator that facilitates the separation of a mixture flow into component parts. The separator includes an upper-tier elongate conduit, a lower-tier elongate conduit and a plurality of spaced apart connectors. Each of the upper and lower-tier elongate conduits has an outlet and at least one of the upper and lower-tier elongate conduits has an inlet for receiving the mixture flow. The upper and lower-tier elongate conduits also each have a plurality of openings such that one connector of the plurality of connectors may interconnect one of the upper-tier elongate conduit openings with a one of the lower-tier elongate conduit openings. The connectors enable communication of at least one of a liquid component and the at least one of another liquid component and a gas component of the mixture flow there between. U.S. Pat. No. 7,540,902 is herein incorporated by reference in its entirety.

U.S. Publication Number 2009/0211763 discloses a Vertical Annular Separation and Pumping System (VASPS) utilizing an isolation baffle to replace a standard pump shroud associated with an electrical submersible pump. The isolation baffle may be a one piece plate positioned so as to direct produced wellbore liquids around the electrical submersible pump motor to provide a cooling medium to prevent overheating and early failure of the electrical submersible pump. U.S. Publication Number 2009/0211763 is herein incorporated by reference in its entirety.

U.S. Publication Number 2009/0035067 discloses a seafloor pump assembly that is installed within a caisson that has an upper end for receiving a flow of fluid containing gas and liquid. The pump assembly is enclosed within a shroud that has an upper end that seals around the pump assembly and a lower end that is below the motor and is open. An eduction tube has an upper end above the shroud within the upper portion of the caisson and a lower end in fluid communication with an interior portion of the shroud. The eduction tube causes gas that separates from the liquid and collects in the upper portion of the caisson to be drawn into the pump and mixed with the liquid as the liquid is being pumped. U.S. Publication Number 2009/0035067 is herein incorporated by reference in its entirety.

International Publication Number WO 2007/144631 discloses a method of separating a multiphase fluid, the fluid comprising a relatively-high density component and a relatively low density component, comprises introducing the fluid into a separation region; imparting a rotational movement into the multiphase fluid; forming an outer annular region of rotating fluid of predetermined thickness within the separation region; and forming and maintaining a core of fluid in an inner region; wherein fluid entering the separation vessel is directed into the outer annular region; and the thickness of the outer annular region is such that the high density component is concentrated and substantially contained within this region, the low density component being concentrated in the rotating core. A separation system employing the method is also disclosed. The method and system are particularly suitable for the separation of solid debris from the fluids produced by a subterranean oil or gas well at wellhead flow pressure. International Publication Number WO 2007/144631 is herein incorporated by reference in its entirety.

International Publication Number WO 2009/047521 discloses equipment and a subsea pumping system using a subsea module installed on the sea bed, preferably away from a production well and intended to pump hydrocarbons having a high associated gas fraction produced by one or more subsea production wells to the surface. A pumping module (PM) is disclosed which is linked to pumping equipment already present in a production well and which basically comprises: an inlet pipe, separator equipment, a first pump and a second pump. In the subsea pumping system for the production of hydrocarbons with a high gas fraction, when oil is pumped from the production well (P) the well pump increases the energy of the fluid in the form of pressure and transmits this increase in energy in the form of an increase in suction pressure in the second pump of the subsea module (PM). International Publication Number WO 2009/047521 is herein incorporated by reference in its entirety.

There is a need in the art for one or more of the following:

An improved system and method of separating gases and liquids in a subsea environment;

An improved system and method of reducing the gas input to a submersible pumping system;

An improved system and method of increasing the throughput of a subsea caisson separator; and

An improved system and method to extend the pump life and reduce maintenance downtime of a submersible liquid pump.

### SUMMARY OF INVENTION

In one aspect of the invention, there is disclosed a method for separating a multiphase fluid, the fluid comprising a relatively high density component and a relatively low density component, the method comprising: introducing the fluid into a separation region; imparting a rotational movement into the multiphase fluid; forming an outer annular region of rotating fluid within the separation region; and forming and maintaining a core of fluid in an inner region; wherein fluid entering the separation vessel is directed into the outer annular region; and the thickness of the outer annular region is such that the high density component is concentrated and substantially contained within this region, the low density component being concentrated in the rotating core.

Advantages of the invention may include one or more of the following:

An improved system and method of separating gases and liquids in a subsea environment;

An improved system and method of reducing the gas input to a submersible pumping system;

An improved system and method of increasing the throughput of a subsea caisson separator; and

An improved system and method to extend the pump life and reduce maintenance downtime of a submersible liquid pump.

### BRIEF DESCRIPTION OF DRAWINGS

FIG. 1 shows a offshore production structure.

FIG. 2 shows a gas and liquid separator.

FIG. 3 shows a gas and liquid separator in accordance with embodiments of the present disclosure.

FIG. 4 shows a gas and liquid separator in accordance with embodiments of the present disclosure.

### DETAILED DESCRIPTION OF THE INVENTION

In one aspect, embodiments of the present disclosure generally relate to a offshore platform for producing oil and/or gas from one or more subsea wells with a subsea pump, for example a spar platform, a tension leg platform, an FPSO, or other offshore structures as are known in the art. In particular, embodiments of the present disclosure relate to one or more subsea wells that are connected to a separator with a gas output and a liquid output, where the liquid output is fed to a subsea pump to transport the liquid to an offshore platform. The offshore platform of the present disclosure may be intended to be deployed across a range of water depths, extending at least from 1,000 to 10,000 feet (300 to 3000 m).

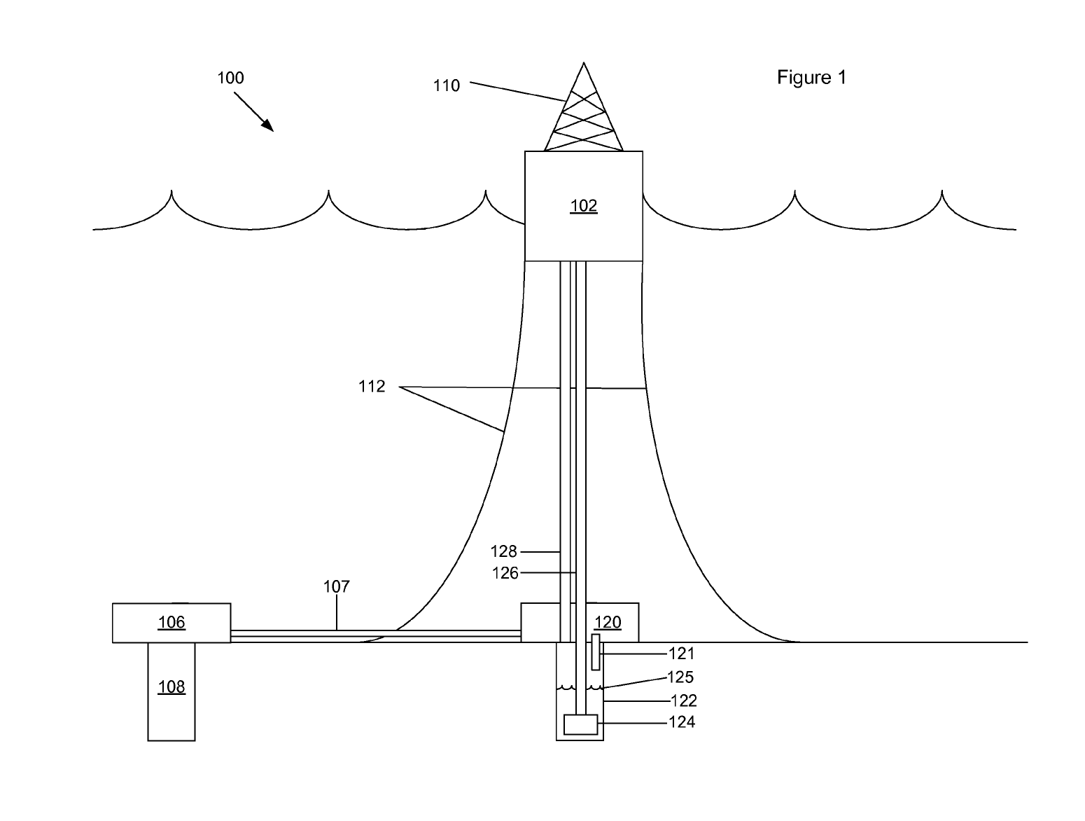

FIG. 1

Referring to FIG. 1, offshore system 100 is shown. System 100 is installed in a body of water, where system 100 includes a floating structure 102 connected to the sea floor by multiple mooring or anchor lines 112. Floating structure 102 may include a drilling rig 110 to drill wells in the sea floor, and other drilling and/or production equipment as is known in the art.

One or more wells 108 are provided in the sea floor to produce liquids and/or gases. Wells 108 are capped with a wellhead 106. Wellhead 106 is connected to a flowline 107 to transport the liquids and/or gases to separation and pumping system 120. Alternatively, the liquids and/or gases from one or more wells 108 may be aggregated at a manifold, then transported by a flowline to pumping system 120.

Although only flowline 107 from one well 108 is shown, multiple flowlines from multiple wells and/or manifolds may be used to transport liquids and/or gases to pumping system 120.

Pumping system 120 includes a mixed liquid and gas inlet 121 into caisson separator 122. Liquid pump 124 is provided at the bottom of caisson separator 122 below liquid level 125. Liquid flowline 126 is connected to pump outlet 124, and gas flowline 128 is connected to caisson separator 122 above liquid level 125. Liquid flowline 126 and gas flowline 128 transport liquid and gas, respectively, to floating structure 102. Produced fluids from well 108 may be transported to floating structure 102 for production processes as are known in the art prior to being shipped, pipelined, or otherwise transported to shore.

In general, floating structure 102 is permanently moored on location and is not moved until the field has been exhausted. Floating structure 102 may have a weight of at least 20,000 metric tons.

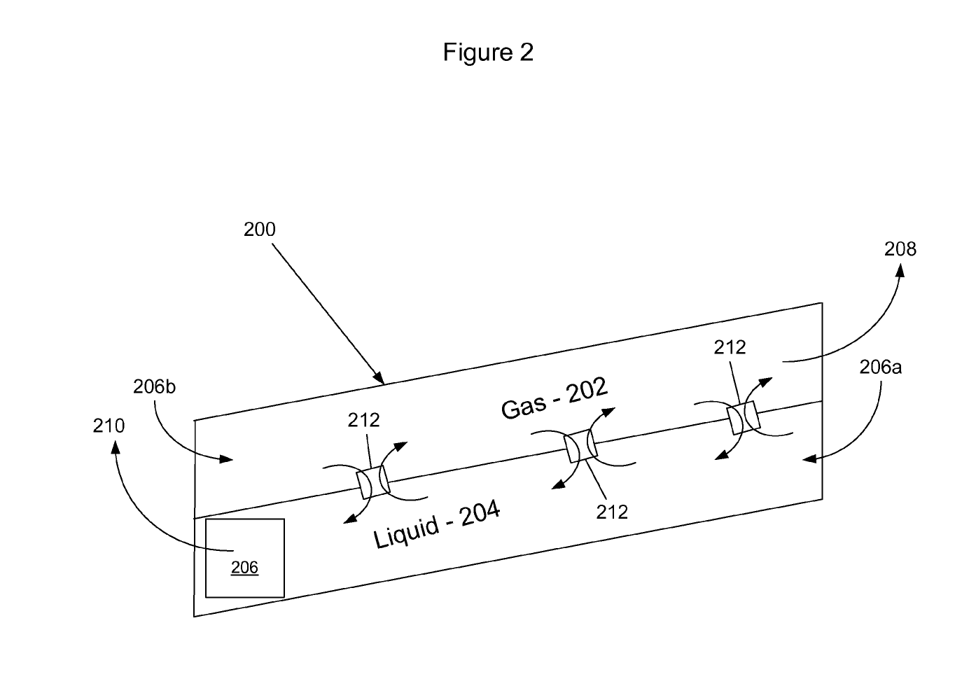

FIG. 2:

Referring to FIG. 2, a separation system 200 is shown in accordance with embodiments of the present disclosure. A mixed liquid and gas inlet 206a is provided into the top of liquid flowpath 204. Liquid flowpath 204 and gas flowpath 202 are inclined at an angle from about 5 to about 60 degrees with respect to horizontal, for example from about 10 to about 45 degrees, or from about 15 to about 30 degrees.

Liquid in the liquid flowpath 204 will gravity drain down towards pump 206 which has a pump outlet connected to a liquid outlet conduit 210. Liquid in the gas flowpath 202 will gravity drain down towards one of the openings 212 provided between liquid flowpath 204 and gas flowpath 202 and fall down into liquid flowpath 204.

Gas in the gas flowpath 202 will float up towards gas outlet conduit 208. Gas in the liquid flowpath 204 will float up towards one of the openings 212 provided between liquid flowpath 204 and gas flowpath 202 and float up into gas flowpath 202.

A second mixed liquid and gas inlet 206b may be provided into the bottom of gas flowpath 202. The liquid outlet 208 and second mixed inlet 206b may or may not be a single liquid pool.

Another suitable separator system is disclosed in U.S. Patent 7,540,902 which is herein incorporated by reference in its entirety.

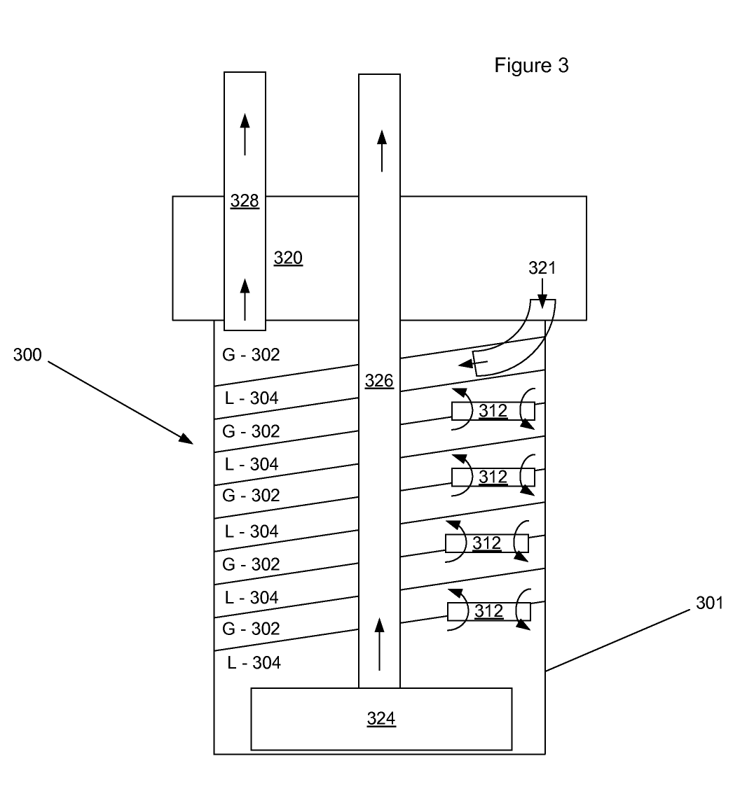

FIG. 3:

Referring to FIG. 3, separator system 300 is illustrated including housing 301, for example a caisson or a cylindrical structure. Within housing 301 are provided a gas flow path 302 and liquid flow path 304. Gas flow path 302 is above liquid flow path 304, and both are helically wound about liquid output 326.

The enclosed helical channels may or may not extend from the housing wall to the pump outlet 326. In one embodiment, the channels are connected and/or sealed to both the housing wall and to the pump outlet 326. In another embodiment, the channels are connected and/or sealed to the housing wall and there is a gap between the helical channels and the pump outlet 326. In another embodiment, the channels are connected and/or sealed to the pump outlet 326 and there is a gap between the helical channels and the housing wall.

In operation, a mixed flow of liquid and gas, or of a heavy and of a light fluid, is introduced from top manifold 320. The caisson inlet functions as a primary gravity separator, which may or may not utilize centrifugal separation. The liquid and entrained gas falls onto the upper helix and flows down liquid flow path 304 and/or gas flow path 302. At the top of liquid flow path 304, the mixed flow starts traveling down liquid flow path 304, with the gas (and/or foam) floating to the top, and the liquid dropping to the bottom. After a certain distance traveling down liquid flow path 304, the mixed flow encounters an opening 312 which allows some of the gas to enter gas flow path 302, while the remainder of the mixed flow continues down liquid flow path 304, until the next opening 312 is encountered.

At the bottom of the liquid flow path 304, a substantial portion of the gas has separated into the gas flow path 302, so that a primarily liquid portion remains in the liquid flow path 304, which goes into pump 324 inlet, for example at least about 80%, 90%, or 95% liquid by volume. Pump 324 has an outlet 326 for pumping the liquid to a desired location, for example a floating production structure.

At the top of the gas flow path 302, substantially all of the liquid has dropped into liquid flow path 304 through one of the openings 312, so that a primarily gas portion remains in the gas flow path 302, which goes through an opening of gas outlet conduit 328, located above the point where the gas liquid mixture enters the helix.

In another embodiment, another mixed flow conduit 321 may be provided at the bottom of gas flow path 302.

In another embodiment, mixed flow conduit 321 may be arranged to provide a tangential flow path so that liquid in the mixed flow is pushed against the housing 301 exterior wall by centrifugal acceleration, and the gas is maintained closer to the interior of the flow path 304 near outlet 326. In such an arrangement, opening 312 may be provided closer to the interior of the flow path 304 near outlet 326 to separate the gas into gas flow path 302.

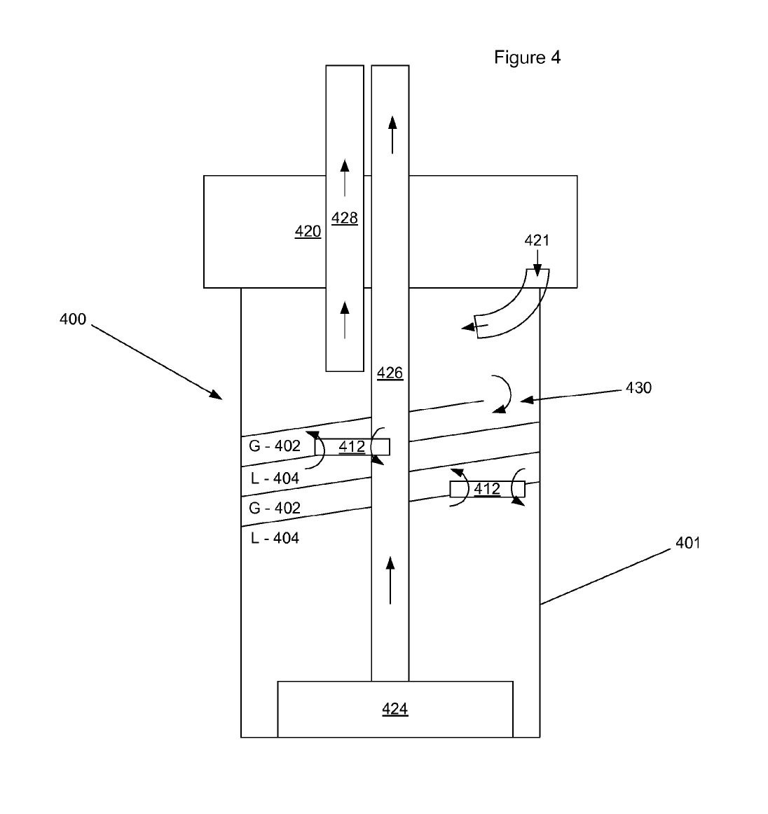

FIG. 4:

Referring to FIG. 4, separator system 400 is illustrated including housing 401, for example a caisson or a cylindrical structure. Within a middle portion of housing 401 is provided a gas flow path 402 and liquid flow path 404. Gas flow path 402 is above liquid flow path 404, and both are helically wound about liquid output 426.

The enclosed helical channels may or may not extend from the housing wall to the pump outlet 426. In one embodiment, the channels are connected and/or sealed to both the housing wall and to the pump outlet 426. In another embodiment, the channels are connected and/or sealed to the housing wall and there is a gap between the helical channels and the pump outlet 426. In another embodiment, the channels are connected and/or sealed to the pump outlet 426 and there is a gap between the helical channels and the housing wall.

In operation, a mixed flow of liquid and gas, or of a heavy and of a light fluid, is introduced from top manifold 420 through mixed flow conduit 421. The caisson inlet functions as a primary gravity separator, which may or may not utilize centrifugal separation, for example by the conduit 421 injecting the mixture tangentially to the housing 401 inner wall, so that the fluid flows around the circumference of the housing 401 inner wall. The liquid and entrained gas then falls onto the upper helix and flows down into opening 430 and into gas flow path 402. At the top of gas flow path 402, the mixed flow starts traveling down gas flow path 402, with the gas (and/or foam) floating to the top, and the liquid dropping to the bottom. After a certain distance traveling down gas flow path 402, the mixed flow encounters an opening 412 which allows some of the liquid to enter liquid flow path 404, while the remainder of the mixed flow continues down gas flow path 402, until the next opening 412 is encountered.

At the bottom of the liquid flow path 404, a substantial portion of the gas has separated into the gas flow path 402, so that a primarily liquid portion remains in the liquid flow path 404, which goes into pump 424 inlet, for example at least about 80%, 90%, or 95% liquid by volume. Pump 424 has an outlet 426 for pumping the liquid to a desired location, for example a floating production structure.

At the top of the gas flow path 402, substantially all of the liquid has dropped into liquid flow path 404 through one of the openings 412, so that a primarily gas portion remains in the gas flow path 402, which goes through an opening of gas outlet conduit 428, located above the point where the gas liquid mixture enters the helix.

In another embodiment, mixed flow conduit 421 may be arranged to provide a tangential flow path so that liquid in the mixed flow is pushed against the housing 401 exterior wall by centrifugal acceleration, and the gas is maintained closer to the interior of the flow path 404 near outlets 426 and 428. In such an arrangement, opening 412 may be provided closer to the interior of the flow path 404 near outlet 426 to separate the gas into gas flow path 402.

### Illustrative Embodiments

In one embodiment, there is disclosed a method for separating a multiphase fluid, the fluid comprising a relatively high density component and a relatively low density component, the method comprising: introducing the fluid into a separation region; imparting a rotational movement into the multiphase fluid; forming an outer annular region of rotating fluid within the separation region; and forming and maintaining a core of fluid in an inner region; wherein fluid entering the separation vessel is directed into the outer annular region; and the thickness of the outer annular region is such that the high density component is concentrated and substantially contained within this region, the low density component being concentrated in the rotating core.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for separating a multiphase fluid, the fluid comprising a relatively high density component and a relatively low density component, the method comprising:
introducing the fluid into a separation region;
imparting a rotational movement into the multiphase fluid;
forming an outer annular region of rotating fluid within the separation region;
and forming and maintaining a core of fluid in an inner region;
wherein fluid entering the separation vessel is directed into the outer annular region;
and the thickness of the outer annular region is such that the high density component is concentrated and substantially contained within this region, the low density component being concentrated in the rotating core.

2. The method according to claim 1, wherein the multiphase fluid comprises a liquid phase and a gaseous phase.

3. The method according to claim 1, wherein the multiphase fluid comprises a liquid phase and a solid phase.

4. The method according to claim 1, wherein the multiphase fluid comprises two immiscible liquid phases.

5. The method according to claim 4, wherein the two immiscible liquid phases are oil and water.

6. The method according to claim 1, wherein the multiphase fluid is produced from a subterranean oil well.

7. The method according to claim 6, wherein the multiphase fluid comprises solid formation materials and/or solid debris.

8. The method according to claim 1, wherein the multiphase fluid is introduced tangentially into the separation region, thereby causing the fluid in the annular region to rotate with the separation region.

9. The method according to claim 8, wherein the multiphase fluid is introduced at an acute angle to the longitudinal axis of the separation region, such that fluid entering the separation region is not impacted by fluid rotating in the outer annular region.

10. The method according to claim 1, wherein the multiphase fluid is introduced into the separation region so as to contact a guide surface, the guide surface inducing a helical flow pattern in the fluid stream within the separation region.

11. The method according to claim 1, wherein the multiphase fluid is introduced into the separation region through an inlet having a rectangular cross-section.

12. The method according to claim 1, wherein high density fluid and low density fluid is removed from a fluid collecting region established downstream of the core region.

13. The method according to claim 1, wherein a low density fluid collecting region is established in the region of the downstream end of the core region, low density fluid being removed from the said collecting region.

14. The method according to claim 13, wherein a high density fluid collecting region is established downstream of the core region, high density fluid being removed from the said collecting region.

15. The method according to claim 14, wherein high density fluid and low density fluid are removed from their respective fluid collecting regions by means of separate conduits.

16. The method according to claim 15, wherein the conduit has a low density fluid outlet and a high density fluid outlet.

17. The method according to claim 12, wherein fluid is removed through a plurality of fluid outlet apertures in the respective conduit.

18. The method according to claim 17, wherein the fluid outlet apertures are arranged tangentially to the flow of fluid in the high density fluid collecting region.

19. The method according to claim 14, wherein high density fluid is removed by means of a siphon.

20. The method according to claim 15, wherein, upon removal from the separating region, the low density fluid flows in an upstream direction and the high density fluid flows in a downstream direction.

21. The method according to claim 1, wherein means are provided to control a vortex forming in the fluid in the separation vessel downstream of the fluid collecting region.

22. The method according to claim 1, further comprising providing a solid concentrating region downstream of the annular and core regions.

23. The method according to claim 21, wherein the solid concentrating region has a fluid flowpath that decreases in cross-sectional area in the direction of fluid flow.

24. The method according to claim 1, further comprising providing a solids separation and removal region downstream of the core and annular regions.

25. The method according to claim 24, wherein smaller solid particles are caused to leave the solids separation and removal region through an outlet arranged centrally within the region.

26. The method according to claim 25, wherein the outlet comprises a plurality of solid outlet apertures.

27. The method according to claim 26, wherein the outlet apertures are arranged tangentially to the rotational flow of the fluid in the solids separation and removal region.

28. The method according to claim 25, wherein larger diameter solid particles are removed from the outer region of the solids separation and removal region.

29. The method according to claim 28, wherein the larger diameter solid particles are removed through an outlet arranged tangentially to the rotating fluid flow.

30. The method according to claim 26, wherein the solids separation and removal region is provided with an inner conduit, through which the fluid stream is causes to flow.

31. The method according to claim 30, wherein the inner conduit is provided with a plurality of outlet apertures forming a solid sieve.

32. The method according to claim 31, wherein the outlet apertures are arranged tangentially to the rotating fluid flow.

33. The method according to claim 1, wherein low density fluid removed from the core region is passed to a fluid separation zone, in which high density fluid is separated from the low density fluid and returned to the annular region in the separating region.

34. The method according to claim 1, wherein low density fluid is removed from the core region downstream of the inlet of the multiphase fluid and a portion of the fluid so removed is reintroduced into the core region adjacent the inlet of the multiphase phase.

35. A separation system for a multiphase fluid containing a high density component and a low density component comprising a separator having:
a separation region;
an inlet for the multiphase fluid to enter the separation region;
means for imparting a rotational movement to the multiphase fluid upon entry into the separation region, so as to form an outer annular region of rotating fluid;
in operation the thickness of the outer annular region being such that the high density component is concentrated and substantially contained within the outer annular region;
and the low density component is concentrated in the core region.

36. The separator system according to claim 35, wherein the means for imparting a rotational movement to the multiphase fluid is the fluid inlet being tangential to the longitudinal axis of the separation region.

37. The separator system according to claim 36, wherein the fluid inlet is at an acute angle to the longitudinal axis of the separation region.

38. The separator system according to claim 36, wherein the fluid inlet has a rectangular cross-section.

39. The separator system according to claim 35, wherein the separation region is provided with a guide adjacent the fluid inlet, the guide having at least one helically extending guide surface disposed to be impacted by fluid entering the separation region through the fluid inlet.

40. The separator system according to claim 35, further comprising a fluid outlet disposed in the portion of the separation region corresponding to downstream of the core region, when in operation.

41. The separator system according to claim 40, wherein the fluid outlet is formed in the end of a conduit extending into the separation region.

42. The separator system according to claim 41, wherein the conduit extends coaxially within the separation region.

43. The separator system according to either of claim 42, wherein the first fluid outlet comprises a plurality of radial openings formed in the conduit.

44. The separator system according to claim 43, wherein the openings are tangential to the flow of fluid surrounding the conduit.

45. The separator system according to claim 35, further comprising a first fluid outlet disposed in the portion of the separation region corresponding to the region adjacent the downstream end of the core region, when in operation.

46. The separator system according to claim 45, wherein the first fluid outlet is formed in the end of a conduit extending into the separation region.

47. The separator system according to claim 46, wherein the conduit extends coaxially within the separation region.

48. The separator system according to either of claim 46, wherein the first fluid outlet comprises a plurality of radial openings formed in the conduit.

49. The separator system according to claim 48, wherein the openings are tangential to the flow of fluid surrounding the conduit.

50. The separator system according to any of claims 45, further comprising a second fluid outlet disposed in the portion of the separation region downstream of that portion occupied by the core region, when in operation.

51. The separator system according to claim 50, wherein the second fluid outlet is formed in the end of a conduit extending into the separation region.

52. The separator system according to claim 51, wherein the conduit extends coaxially within the separator region.

53. The separator system according to either of claims 51, wherein the second fluid outlet comprises a plurality of radial openings formed in the conduit.

54. The separator system according to claim 53, wherein the openings are tangential to the flow of fluid surrounding the conduit.

55. The separator system according to any of claims 50, wherein the first and second fluid outlets open into the same conduit.

56. The separator system according to claim 55, wherein the conduit has an outlet for each of the low density fluid and the high density fluid.

57. The separator system according to claim 35, further comprising a vortex controller situated within the separation region in a position corresponding to downstream of the core region, when in use.

58. The separator system according to claim 35, further comprising a solids concentration region within the separation region having a cross-sectional area lower than the cross-sectional area of the separation region adjacent the fluid inlet.

59. The separator system according to claim 58, wherein the reduced cross-sectional area is provided by a tapered portion of the wall of the separator.

60. The separator system according to claim 58, wherein the reduced cross-section area is provided by a cone extending coaxially within the separation region.

61. The separator system according to claim 35, further comprising a means for separating solids from fluid within the separation region.

62. The separator system according to claim 61, wherein the solid separation means comprises a conduit extending coaxially within the separation region, the conduit having a plurality of radially extending openings.

63. The separator system according to claim 62, wherein the openings are tangential to the flow of fluid around the conduit.

64. The separator system according to claim 61, wherein the solid separation means comprises a solid entrapment zone disposed around the separation region and separated from the solid entrapment zone by a wall having a plurality of radially extending openings.

65. The separator system according to claim 64, wherein the openings are tangential to the flow of fluid in the separation region.

66. The separator system according to claim 35, further comprising means for removing solid material from the separation zone operable on an intermittent basis.

67. A subsea processing assembly comprising:
a wellhead assembly through which fluids are produced from a subterranean well;
a separator assembly having a fluid inlet connected to the wellhead assembly for receiving the fluids produced from the well, the separator assembly being operable at wellhead pressure to remove well debris entrained in the fluids to produce a solids rich phase and a fluid phase, the separator assembly comprising a fluid outlet for the fluid phase;
and a choke assembly having an inlet connected to the fluid outlet of the separator assembly.

68. A platform processing assembly comprising:
a fluid receiving assembly for receiving fluids produced from a subterranean well;
a separator assembly having a fluid inlet connected to the fluid receiving assembly for receiving the fluids produced from the well, the separator assembly being operable at wellhead pressure to remove well debris entrained in the fluids to produce a solids rich phase and a fluid phase, the separator assembly comprising a fluid outlet for the fluid phase;
and a choke assembly having an inlet connected to the fluid outlet of the separator assembly.

69. A method for separating solid particles from a multiphase fluid stream, the fluid stream comprising a liquid component and a gas component, the method comprising: introducing
the stream into a separation region;
imparting a rotational movement into the fluid;
forming an outer annular region of rotating fluid of predetermined thickness;
and forming and maintaining a core of gas in an inner region;
wherein liquid and solid particles entering the separation vessel are directed to the outer annular region;
and the thickness of the outer annular region is such that the solid particles are concentrated and substantially contained within this region.

70. A method of separating a multiphase fluid stream, the method comprising introducing the stream into a separation region in a manner to induce a rotational flow pattern within the separation region, wherein, prior to its introduction into the separation region, the fluid stream is caused to flow along an arcuate flowpath, the fluid flowing along the arcuate flowpath in an orientation corresponding to the rotational flow pattern within the separation region.

71. The method according to claim 70, wherein the arcuate flowpath is helical.

72. The method according to claim 70, wherein the fluid stream in the arcuate flowpath is flowing in a laminar or transitional flow regime.

73. The method according to claim 70, wherein the multiphase stream comprises at least one fluid phase and a solid phase.

74. The method according to claim 70, wherein the fluid stream is produced from a subterranean well.

75. An apparatus for separating a multiphase fluid stream, the apparatus comprising:
a separation region;
an inlet for introducing a fluid stream into the separation region;
an arcuate conduit for conveying a fluid stream to the inlet;
wherein the arcuate conduit and the inlet are arranged to introduce the fluid stream into the separation region in an orientation corresponding to that of the fluid within the separation region during operation.

76. The apparatus according to claim 75, wherein the arcuate conduit is helical.
